(19) United States
(12) Patent Application Publication
(10) Pub. No.: US 2022/0314492 A1
(43) Pub. Date: Oct. 6, 2022

(54) CONCRETE MIXER TRUCK DRUM ROTATION MEASUREMENT USING CAMERA

(71) Applicant: Sysdyne Technologies LLC, Stamford, CT (US)

(72) Inventor: Guoyao Zhang, Stamford, CT (US)

(21) Appl. No.: 17/222,378

(22) Filed: Apr. 5, 2021

(51) Int. Cl. B28C 5/42

(52) U.S. Cl. CPC B28C 5/422; B28C 5/4272

(57) ABSTRACT

Embodiments disclose systems and methods to measure concrete mixer truck drum rotation. A camera (e.g., a video camera or Infra-Red (“IR”) camera) may capture images of a surface of a concrete mixer truck drum. A drum rotation measurement platform may receive the images of the surface of a concrete mixer truck drum captured by the camera and automatically analyze the captured images using machine learning technology to determine drum rotation information (e.g., a drum rotation speed and/or drum rotation direction). The drum rotation measurement platform may then output an indication of the determined drum rotation information. In some embodiments, the surface of the concrete mixer truck drum may include one or more marking symbols (e.g., of various shapes), and the automatic analysis performed by the drum rotation measurement platform includes detection of movement of the marking symbol between captured images.

### TECHNICAL FIELD

Some embodiments are directed to concrete mixer truck drum rotation measurement. In particular, some embodiments disclose using a camera to measure concrete mixer truck drum rotation.

### BACKGROUND

Concrete mixer trucks are used to transport or deliver loads of mixed, non-hardened concrete, a mix of cementitious materials with aggregate, water and chemical additives. Mixer trucks typically have a rotatable mixing drum for storing the cement mixture and a hydraulic system and mixing drum controller for controlling the rotation of the drum. The agitation caused by rotating the mixing drum may, for example, help mix all constituents of the mix properly while the mixer truck is in transit. It also may prevent the cement mixture from setting up and hardening. It is known to use mechanical sensors (e.g., magnetic proximity sensors) to measure the speed and detect the direction of mixing drum rotation. Such mechanical sensors, however, can be susceptible to failure especially in view of the harsh environments experienced by concrete mixer trucks (e.g., substantial vibrations, extreme weather conditions, and general construction site issues). The proximity limit (typically a maximum of 33 millimeters) can be difficult to maintain in such a harsh environment.

A need, therefore, exists for improved systems and methods to measure concrete mixer truck drum rotation.

### SUMMARY

According to some embodiments, systems and methods maybe provided to measure concrete mixer truck drum rotation. A camera (e.g., a video camera or Infra-Red (“IR”) camera located, for example, in a cabin area of the truck) may capture images of a surface of a concrete mixer truck drum. A drum rotation measurement platform may receive the images of the surface of a concrete mixer truck drum captured by the camera and automatically analyze (e.g., using machine learning) the captured images to determine drum rotation information (e.g., a drum rotation speed and/or drum rotation direction). The drum rotation measurement platform may then output an indication of the determined drum rotation information. In some embodiments, the surface of the concrete mixer truck drum may include one or more marking symbols (e.g., of various shapes), and the automatic analysis performed by the drum rotation measurement platform includes detection of movement of the marking symbol between captured images.

Some embodiments comprise: means for receiving, by a computer processor of a drum rotation measurement platform, images of a surface of a concrete mixer truck drum captured by a camera; means for automatically analyzing the captured images to determine drum rotation information; and means for outputting an indication of the determined drum rotation information.

Some technical advantages of some embodiments disclosed herein are improved systems and methods to measure concrete mixer truck drum rotation using a camera.

### BRIEF DESCRIPTION OF THE DRAWINGS

FIG. 1 shows a typical concrete mixer truck.

FIG. 2 illustrates a concrete mixer truck in accordance with some embodiments.

FIG. 3 is a concrete mixer truck method according to some embodiments.

FIG. 4 is a high-level system architecture in accordance with some embodiments.

FIG. 5 is a computer vision system according to some embodiments.

FIG. 6 is a system with a plurality of marking symbols in accordance with some embodiments.

FIG. 7 is a system utilizing fewer than all of the marking systems at any given time according to some embodiments.

FIG. 8 illustrates a Region of Interest (“ROI”) in accordance with some embodiments.

FIG. 9 is a system with a plurality of different marking symbol shapes in accordance with some embodiments.

FIG. 10 is a system architecture in accordance with some embodiments.

FIG. 11 is a graphical user interface display according to some embodiments.

FIG. 12 is a communication system in accordance with some embodiments.

FIG. 13 is a more detailed system architecture in accordance with some embodiments.

FIG. 14 is a platform or apparatus in accordance with some embodiments.

FIG. 15 is a rotation measurement database according to some embodiments.

FIG. 16 is a computer tablet in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

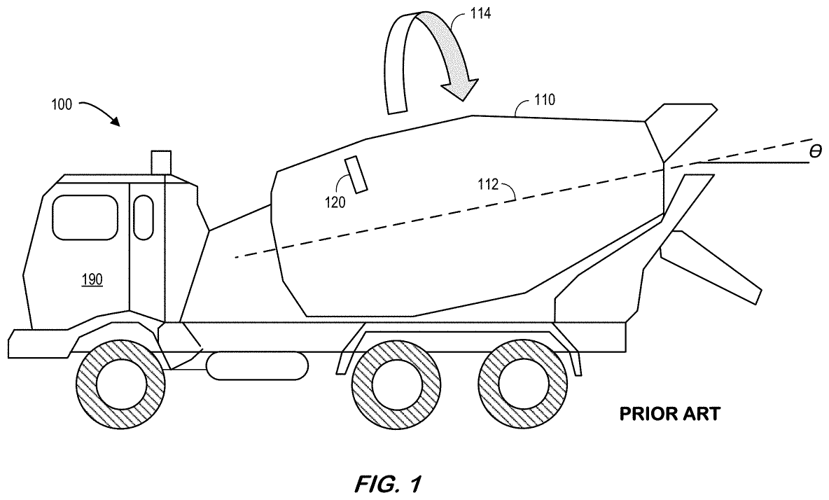

Mobile concrete mixing trucks may mix concrete and deliver that concrete to a site where the concrete is required. Generally, concrete ingredients are loaded into the truck at a central depot and a certain amount of liquid (e.g., water) may be added prior to transport. FIG. 1 shows a typical concrete mixer truck 100. The truck 100 includes a cabin area 190 occupied by a driver and a mixing drum 110 that rotates 114 about an axis 112 (e.g., at an angle θ to the horizon). It is known that a mechanical sensor 120 may be located on the truck 100 to measure rotation of the mixing drum 110 (e.g., rotation speed and direction). Note that if concrete is mixed with excess liquid, the resulting concrete may not dry with the required structural strength. Thus, if a concrete mixing truck delivers a concrete mix to a site with excess water is added, it may be necessary for the concrete mixing truck to return to the depot in order to add extra particulate concrete ingredients to correct the problem. If the extra particulate ingredients are not added within a relatively short time period after excessive liquid has been added, the mix may still not dry with the required strength. As a result, the measurements made by the mechanical sensor 120 may be carefully monitored. However, these types of sensors can be difficult to install. Moreover, the harsh environment associated with these types of mixer trucks 100 make such mechanical sensors 120 prone to frequent failure.

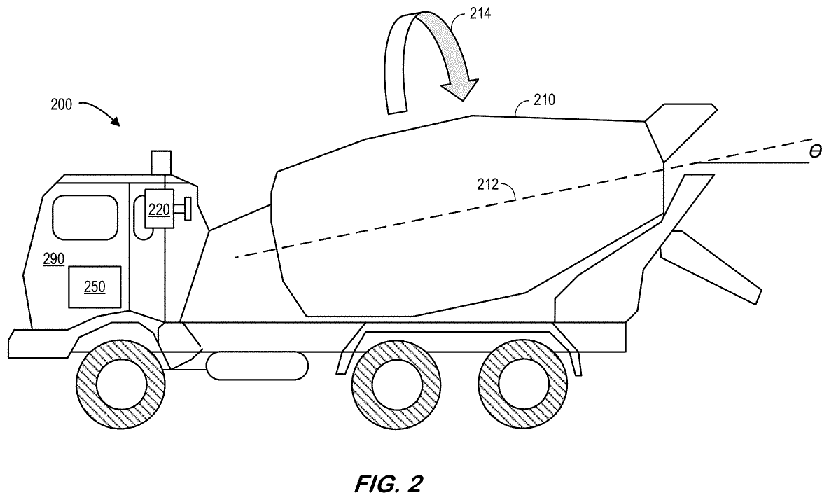

FIG. 2 illustrates a concrete mixer truck 200 in accordance with some embodiments. Although a particular truck 200 is illustrated in FIG. 2, note that embodiments may be practiced using any type of concrete mixer truck 200 (e.g., a rear loader or front loader truck 200, etc.). As before, the truck 200 includes a cabin area 290 occupied by a driver and a mixing drum 210 that rotates 214 about an axis 212 (e.g., at an angle θ to the horizon). According to some embodiments, a camera 220 (e.g., a video camera or an IR camera) may be located on the truck 200 to measure rotation of the mixing drum 210 (e.g., rotation speed and direction). Images (including video images) from the camera 220 may be analyzed by a drum rotation measurement platform 250, such as a small board processing unit, a mini-Personal Computer (“mini-PC”) processing unit, a tablet computer, a platform wired to the camera 220, a platform in wireless communication with the camera 220, etc. Note that the camera 220 and/or drum rotation measurement platform 250 might be located inside and/or outside the cabin area 290.

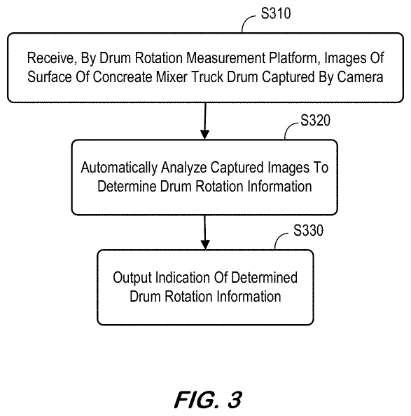

In this way, the system may use the camera 220 to measure rotation 214 of the drum 210. For example, FIG. 3 illustrates a method that might be performed by some or all of the elements of the truck 200 described herein in connection with FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of a drum rotation measurement platform may receive images of a surface of a concrete mixer truck drum captured by a camera. According to some embodiments, the camera is located in a cabin area of the concrete mixer truck (e.g., to protect it from weather and other harsh construction site environmental characteristics). In other embodiments, the camera may be located outside the cabin area. At S320, the system may automatically analyze the captured images to determine drum rotation information (e.g., a drum rotation speed and/or a drum rotation direction). According to some embodiments, the automatic analysis utilizes Machine Learning (“ML”) techniques. As used herein, the phrase ML may refer to, for example, computer algorithms that improve automatically through experience and may be associated with any type of Artificial Intelligence (“AI”) technology. A ML algorithm may build a model based on sample data, referred to as “training data,” to make predictions and/or decisions.

At S330, the system may output an indication of the determined drum rotation information. For example, the drum rotation measurement platform might output the indication of the determined rotation information to a storage device, a smartphone, a tablet computer, a wireless communication network, a cloud computing environment, etc.

According to some embodiments, the surface of the concrete mixer truck drum includes a marking symbol, and the automatic analysis performed by the drum rotation measurement platform includes detection of movement of the marking symbol between captured images. For example, the surface of the concrete mixer truck drum might include a plurality of marking symbols recognized via a computer vision process. According to some embodiments, the captured images include a subset of the plurality of marking symbols and/or the surface of the concrete mixer truck drum may include a plurality of different marking symbol shapes. Note that a marking symbol might be detected based on control parameters (e.g., a computer vision blob shape area, a threshold, a color, a size, a shape, a shape circularity, a shape convexity, an inertia ratio, and other control parameter, etc.)

In some embodiments, the drum rotation information is used to automatically perform a determination of a characteristic of a substance in the concrete mixer truck drum. In other embodiments, the information might be used to control rotation of the concrete mixer truck drum, generate an alert message associated with a substance in the concrete mixer truck drum, train a predictive model, etc.

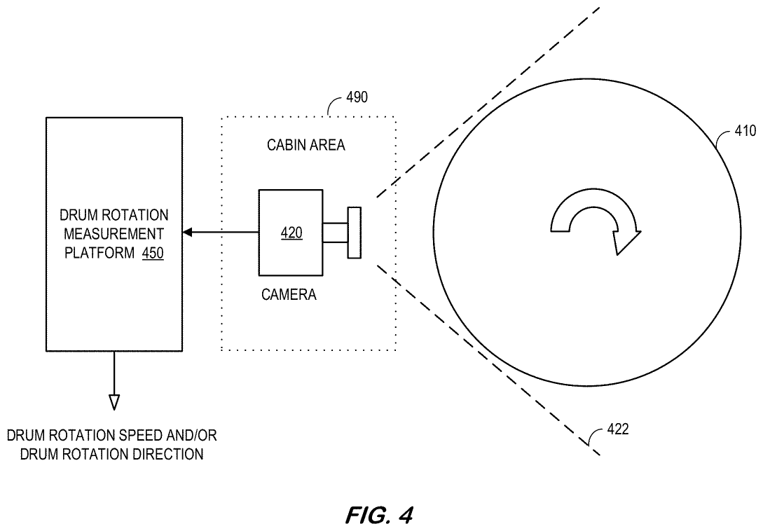

FIG. 4 is a high-level system 400 architecture in accordance with some embodiments. A camera 420 may exchange information with a drum rotation measurement platform 450. The camera 420 may, for example, have a field of view 422 that is able to capture at least some of a surface area of a drum 410 (e.g., the surface facing the front of the truck). Note that other surface areas of the drum 410 might be analyzed instead (e.g., a surfacing facing the back or side of the truck). The drum rotation measurement platform 450 uses image information captured by the camera 420 to calculate and output a drum 410 rotation speed (e.g., Revolutions Per Minute (“RPM”)) and/or a drum rotation direction (e.g., clockwise or counterclockwise). Some or all of the processes described herein might be performed automatically or be initiated via a command from a remote operator device. As used herein, the term “automatically” may refer to, for example, actions that can be performed with little or no human intervention.

As used herein, devices, including those associated with the system 400 and any other device described herein, may exchange information via any communication network which may be one or more of a hard-wired network, a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The drum rotation measurement platform 450 may store information into and/or retrieve information from various data stores (e.g., a rotation measurement database 1500), which may be locally stored or reside remote from the drum rotation measurement platform 450. Although a single drum rotation measurement platform 450 is shown in FIG. 4, any number of such devices may be included. Moreover, various devices described herein might be combined according to embodiments of the present invention. For example, in some embodiments, the drum rotation measurement platform 450 and the rotation measurement database 1500 might comprise a single apparatus. Any of the system 400 functions may be performed by a constellation of networked apparatuses, such as in a distributed processing or cloud-based architecture.

A user or administrator may access the system 400 via a remote operator device (e.g., a PC, tablet, or smartphone) to view information about, adjust drum 410 rotation or camera 420 settings, and/or manage operational information in accordance with any of the embodiments described herein. In some cases, an interactive graphical user interface display may let an operator or administrator define and/or adjust certain parameters (e.g., to define distances or angles) and/or provide or receive automatically generated recommendations or results from the system 400.

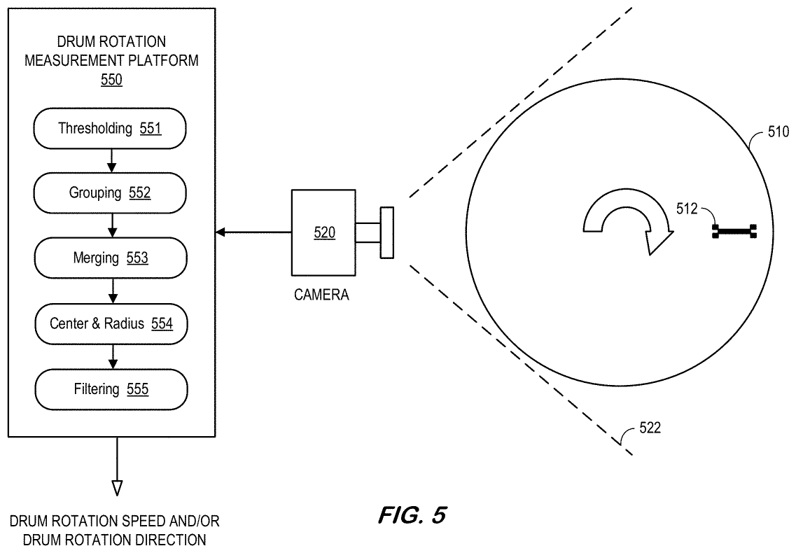

According to some embodiments, computer vision may be used to help accurately determine rotation information about the drum 410. For example, FIG. 5 is a computer vision system 500 according to some embodiments. As before, a camera 520 may exchange information with a drum rotation measurement platform 550. The camera 520 has a field of view 522 that is able to capture at least some of a surface area of a drum 510. The drum rotation measurement platform 550 uses computer vision and image information captured by the camera 520 to calculate and output a drum 510 rotation speed and/or direction.

The drum rotation measurement platform 550 and other elements of the system 500 may operate using 12 Volts of Direct Current (“VDC”) which may be readily available on a concrete mixer truck. In some embodiments, the system 500 may utilize a 3G/4G communication network and/or a smartphone (e.g., using an Android or iOS operating system). Embodiments may also utilize analogue signals to allow for communications associated with water meter readings, truck start/stop signal, etc.

The drum rotation measurement platform 550 may be powerful enough to handle grabbing images and processing them to extract velocity/direction (e.g., at 2 Hz rate) and communication with a server to send extracted information. The drum rotation measurement platform 550 might comprise a small board system (e.g., a Raspberry 4B, an Nvidia Jetson Nano, a Banana Pi M3, etc.), a Mini-PC (e.g., an Intel NUC, a ThinkCentre M90n IoT, etc.), a small tablet with cellular and Windows or Linux, etc.), etc.

The camera 520 may detect at least one marking symbol 512 on the drum 510 and/or be associated with a frame rate (e.g., how many image Frames Per Second (“FPS”) are captured and output). Assuming a maximum RPM of 60, the system may experience 1 rotation per second. Another relevant aspect may be the shutter speed of the camera 520, because the camera 520 may need to grab the image as fast as possible. This can reduce motion blur and the impact of vibrations from the environment. Still another requirement is the need for the system 500 to work during the day and at night. In such situations, an IR camera 520 may be appropriate. Some embodiments may utilize a Raspberry camera (e.g., a SONY® sensor IMX219 with a minimum shutter speed of 200 μs) or a pi noir IR camera v2 that connect directly to a Raspberry's camera module port. Such an approach may be lighter on CPU usage while grabbing the images (which may be relevant given the limited processing power of a Raspberry). Assume that a marker 512 is placed at 1 meter from the axis of rotation (assuming a drum 510 width of 2.5 meter, the drum 510 will have an overall 1.25 meter radius). Thus, the system 500 will have a circumference of +/−6.28 meters. For a 200 μs shutter speed, there is a maximum motion of 1.256 millimeter in a perfect scenario (no vibrations), which should be appropriate. Markers 512 closer to the center may have less blur. In some embodiments, the system 500 may communicate with remote devices, such as via a traditional 4G USB modem, a Verizon Global Modem USB, a Sprint NetStick USB Modem, an AT&T Global Modem USB, a Wi-Fi Mobile hotspot, etc.

Embodiments might utilize a marker detector which could be configured as follows:

```
markerDetector:
  blobDetectorParams:
    filterByArea: true
    maxArea: 5000
    minArea: 400
  maxDetectionsSharedMemory: 20
  threshold: 50
```

Some embodiments may be based on the Open Computer Vision (“OpenCV”) blob detection method which has a fair amount of control parameters. These fall in the blobDetectorParams section, and (as long as the name of the attribute in the yaml matches) it will be applied properly. Parameters such as filterByArea, minArea and maxArea are examples of attributes that might be used in a manual tuning process. Additional parameters include maxDetectionsSharedMemory which controls the maximum number of detections stored in the memory at any given moment. This is influenced by the number of the markers and field of view 522 of the camera (and should allow for erroneous detections that will be trimmed out in other steps). However, too large of a value can impact the performance of the whole system 500. The threshold binary pixel intensity threshold (e.g., from 0 to 255) may imply that any value lower than threshold will be converted to black and any value higher than the threshold will be converted to white. This may reduce the noise and non-relevant parts of the image. With black markers, this value may be set as low as possible so that the system ends up only seeing the markers 512.

According to some embodiments, the drum rotation measurement platform 550 uses OpenCV to detect the marker 512 as an image “blob.” A “blob” is a group of connected pixels in an image that share some common property (e.g., grayscale value). For example, dark connected regions may be considered blobs and the goal of blob detection is to identify and mark these regions. OpenCV provides a way to detect blobs and filter them based on different characteristics. In particular, SimpleBlobDetector is controlled by several processes including a thresholding process 551 that converts the source images to several binary images by thresholding the source image with thresholds starting at minThreshold. These thresholds may be incremented by thresholdStep until maxThreshold. As a result, the first threshold is minThreshold, the second is minThreshold+thresholdStep, the third is minThreshold+2×thresholdStep, etc.

A grouping process 552 may group together connected pixels in each binary image, and the centers of the binary blobs in the binary images may be computed. A merging process 553 may arrange for blobs located closer than minDistBetweenBlobs are merged. A center and radius calculation process 554 may calculate and return the centers and radii of the newly merged blobs. A filtering process 555 may then filter blobs, such as by color, size, shape, etc. A shape filter might, for example, select blobs based on circularity (e.g., a hexagon has higher circularity than a square), convexity, inertia ratio (e.g., how elongated a shape is), etc.

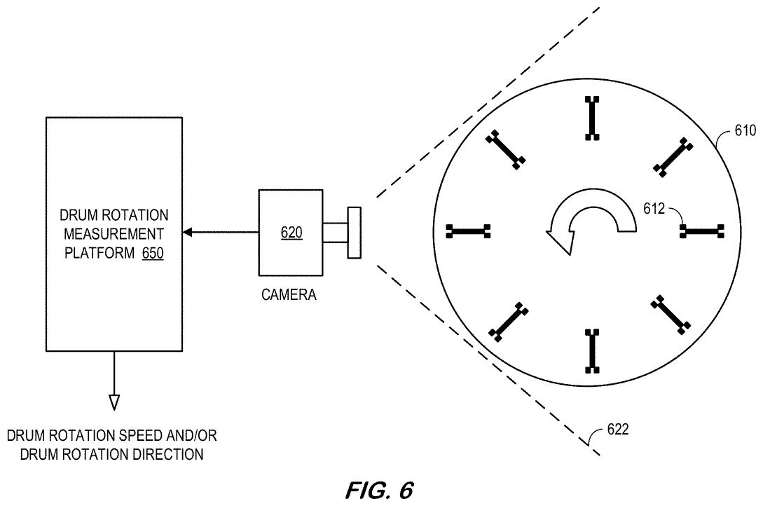

FIG. 5 shows an example of a mixer drum 510 with a single marker 512 or blob. FIG. 6 is a system 600 with a plurality of marking symbols in accordance with some embodiments. As before, a camera 620 may exchange information with a drum rotation measurement platform 650. The camera 620 has a field of view 622 that is able to capture at least some of a surface area of a drum 610, including a number of identical markers 612. The drum rotation measurement platform 650 uses computer vision and image information captured by the camera 620 to calculate and output a drum 610 rotation speed and/or direction.

In some embodiments, the markers 612 may be placed at intervals of from approximately 20° to approximately 25°. Assuming 20° separation, then 360°/20° might imply a minimum of 18 FPS of camera 620 readout. Note that embodiments may minimize the motion of the markers 612 in consecutive frames, so frame rates of 30 FPS or 60 FPS may be used. Based on the size of the markers 612, embodiments may have an even smaller interval (which may also help to reduce readout speed).

Some embodiments might utilize a data estimator which could be configured as follows:

```
dataEstimator:
  numFrames4Average: 10
  numMarkers: 14
  maxRPM: 60
  minNumMarkers2Calibrate: 3
  calibrationInterval: 20
```

The numFrames4Average may represent a number of frames used to average the instantaneous velocity of each processed frame. The numMarkers may represent a number of markers in the drum 510 and the maxRPM may represent a maximum tolerable RPM. This may act, for example, as a boundary in case there are erroneous detections. The minNumMarkers2Calibrate is associated with a system that self-calibrates (estimates the distance in pixels between markers 512) based on the first frame and assuming a certain number of markers are visible. This is a minimum number of visible markers required for a frame to be considered as valid for calibration. This number should take into account the total number of markers 512 on the drum 510. Note that the first one or more frames captured by the camera 520 may be relevant for calibration. The calibrationInterval may represent a number of frames to analyze to reduce erroneous detections for the calibration of the pixel to RPM conversion.

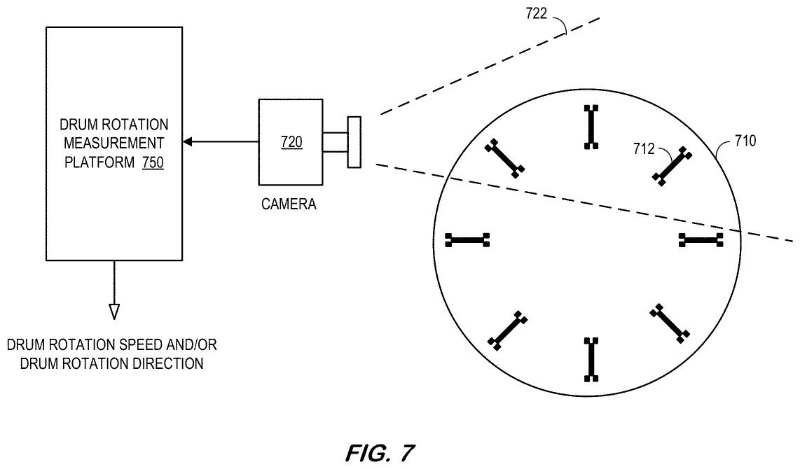

In the embodiments described thus far, the cameras have had a field of view capable of viewing an entire mixer drum surface. Note, however, that this might not be the case in actual implementations (e.g., due to truck mechanics, camera placement, etc.). For example, FIG. 7 is a system 700 utilizing fewer than all of the marking systems at any given time according to some embodiments. Once again, a camera 720 may exchange information with a drum rotation measurement platform 750. The camera 720 has a field of view 722 that is able to capture some, but not all of a surface area of a drum 710, including a subset of a number of identical markers 712 (e.g., a subset of three markers 712 out of a total of eight markers 712 are captured by the camera 720 in FIG. 7). The drum rotation measurement platform 750 can still use computer vision and the limited image information captured by the camera 720 to calculate and output a drum 710 rotation speed and/or direction.

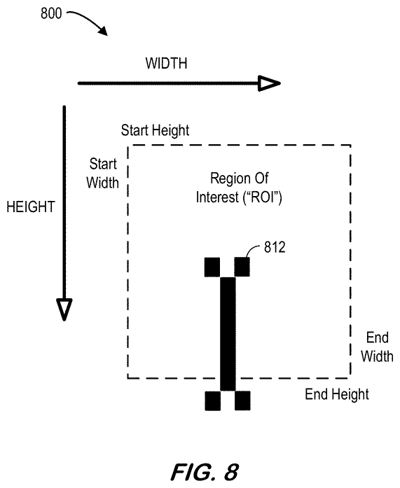

Note that a video analyzer might focus on a specific area when making calculations. For example, FIG. 8 illustrates a Region of Interest (“ROI”) 800 in accordance with some embodiments. A camera configuration file might include the following parameters:

```
camera:
  fps: 40
  resolution:
    height: 480
    width: 640
  shutterSpeed: 25
  videoStabilization: false
```

The fps may represent a desired framerate (e.g., not guaranteed). Note that different framerates might have different fields of view (e.g., a recommended fps may be 40). The resolution may include both a height and a width (e.g., which may be 480 and 640 recommended, respectively). The shutterSpeed may be bound by the desired fps (e.g., and 25 may be recommended). The videoStabilization may enable or disable a camera's built-in video stabilization. A video analyzer configuration file may include the following parameters:

```
videoAnalyser:
  ROI:
    endHeight: 480
    endWidth: 640
    startHeight: 0
    startwidth: 320
```

The ROI 800 defines the part of the image that is analyzed looking for blobs or markers 812. Note that blobs or markers 812 might be painted or glued onto a drum, applied via glue (e.g., a sticker), etc. Moreover, in some embodiments the blobs or markers 812 might comprise three-dimensional shapes (e.g., a portion of a sphere), QR codes, etc. Note that a marker 812 might take the form of a simple shape (such as a circle or a square) or have a more complex pattern composed of sharp lines and edges. According to some embodiments, the colors of the marker 812 and drum are not relevant as long as there is sufficient contrast between the background and the lines. Moreover, note that it may be possible to have multiple marking symbols or a single one that occupies the full visible area of drum (e.g., a pattern that covers the drum entirely). In some embodiments, the ROI 800 might represent a subset of the resolution specified in the camera configuration file. The ROI 800 is controlled via startWidth and endWidth for the x-axis and startHeight and endHeight for y-axis as illustrated in FIG. 8.

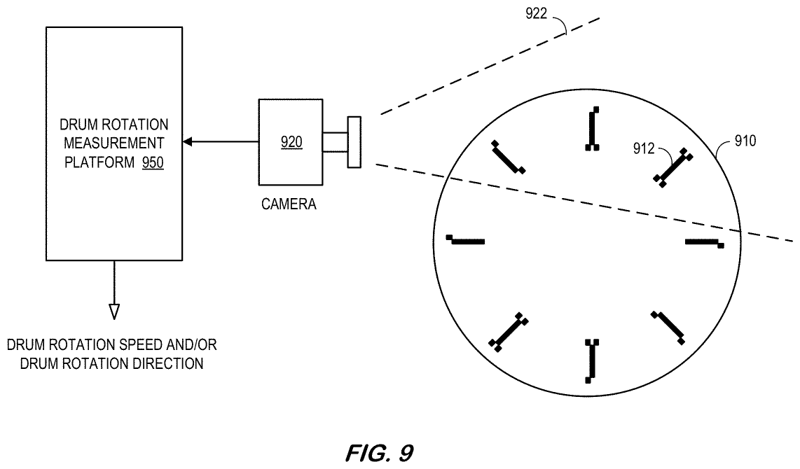

Note that more than one marker shape might be detected by a video analyzer. For example, FIG. 9 is a system 900 with a plurality of different marking symbol shapes in accordance with some embodiments. As before, a camera 920 may exchange information with a drum rotation measurement platform 950. The camera 920 has a field of view 922 that is able to capture some, but not all of a surface area of a drum 910, including a subset of a number of markers 912 having various shapes (e.g., a subset of three markers 912 out of a total of eight markers 912 are captured in FIG. 9). In the example of FIG. 9, four different shapes are used and repeated one time for a total of eight markers. The marker 912 shapes include a rectangular body with either 1, 2, 3, or 4 squares attached at the corners. The drum rotation measurement platform 950 again use computer vision and the limited image information captured by the camera 920 to calculate and output a drum 910 rotation speed and/or direction.

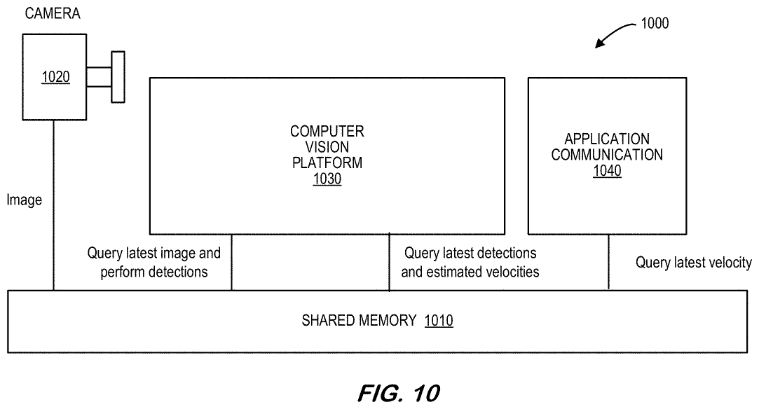

FIG. 10 is a system 1000 code architecture in accordance with some embodiments. A camera 1020, a computer vision platform 1030, and application communication 1040 exchange information via a shared memory. The camera 1020 may, for example, send an image to the shared memory 1010. The computer vision platform 1030 and shared memory 1010 may exchange queries for the latest image and perform detections as well as queries for the latest image and estimated velocities. The application communication 1040 and shared memory 1010 may exchange queries for the latest velocities (e.g., mixer drum rotation speeds). Such an approach to code architecture may improve system 1000 performance by letting the various elements operate in parallel.

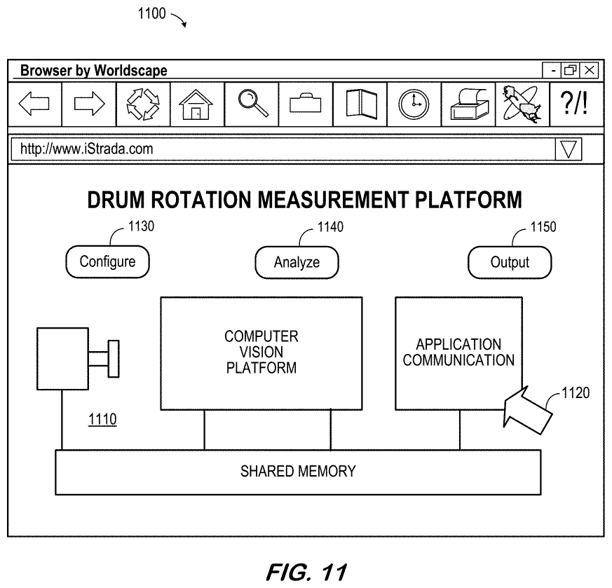

According to some embodiments, an administrator or operator interface may display various Graphical User Interface (“GUI”) elements. For example, FIG. 11 illustrates a GUI display 1100 in accordance with some embodiments of the present invention. The display 1100 may include a graphical representation 1110 of elements of a drum rotation measurement platform. According to some embodiments, an administrator or operator may then select an element (e.g., via a touchscreen or computer mouse pointer 1120) to see more information about that element and/or adjust operation of the system. Selection of a “Configure” icon 1130, “Analyze” icon 1140, or “Output” icon 1150 may also allow for initiation and/or alteration of the system's operation.

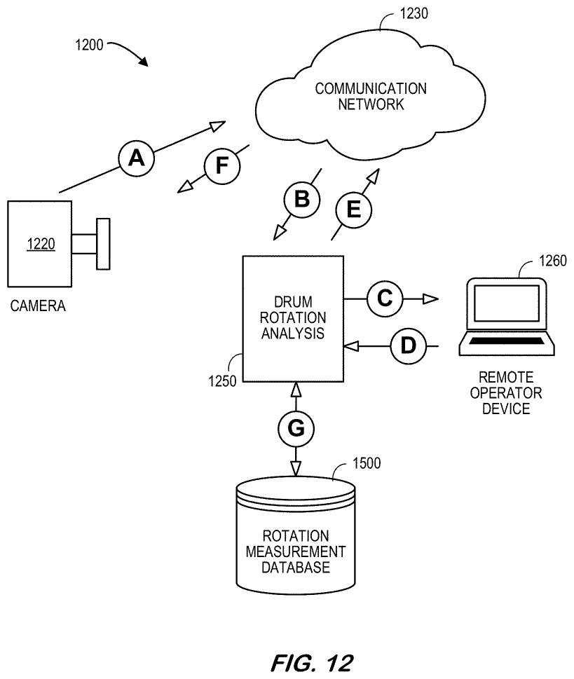

FIG. 12 is a communication system 1200 in accordance with some embodiments. At (A), a camera 1220 may send information to a drum rotation analysis computer 1250 at (B) via a communication network 1230. Some or all of the processes described herein might be performed automatically or be initiated via a command at (D) from a remote operator device 1260 monitoring the process at (C). At (E) and (F) information may be returned to the camera 1220 (e.g., to control operation of the camera frame rate, adjust where the camera is pointed), etc. The drum rotation analysis computer 1250 may store information into and/or retrieve information from various data stores (e.g., the rotation measurement database 1500 at (G)), which may be locally stored or reside remote from the drum rotation analysis computer 1250.

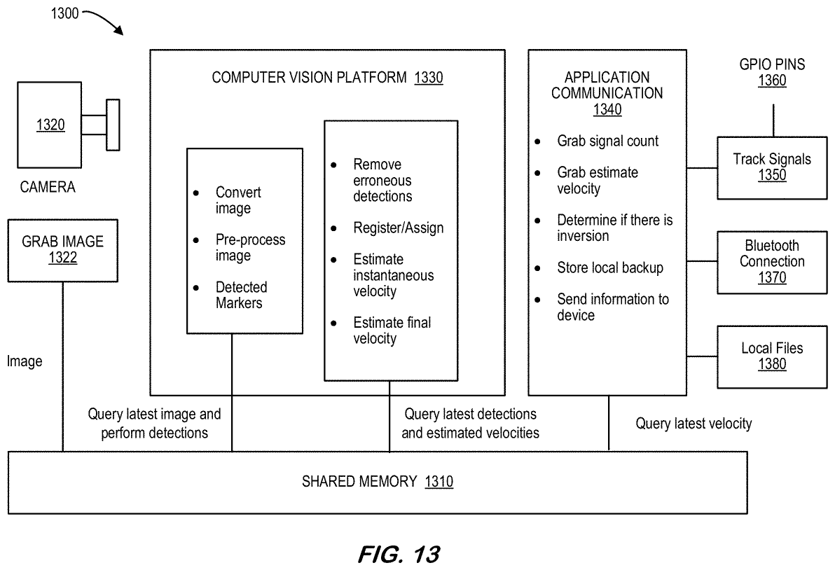

FIG. 13 is a more detailed system architecture 1300 in accordance with some embodiments. A camera 1320, a computer vision platform 1330, and application communication 1340 exchange information via a shared memory. The camera 1320 may, for example, send an image to the shared memory 1310 via grab image 1322. The grab image 1322 may access a python raspberry Application Programming Interface (“API”) to grab the images (e.g., in a separate process with the data placed in a queue that is shared with other processes).

The computer vision platform 1330 and shared memory 1310 may exchange queries for the latest image and perform detections as well as queries for the latest image and estimated velocities. The computer vision platform 1330 may convert and pre-process an image to detect markers. For example, a video analyzer grabs the images from the camera 1320 and convert them to an OpenCV understandable format. The video analyzer may also be responsible for managing an information flow between a marker detector and a velocity estimator. The marker detector may detect where the marker (and potentially which marker) is on the image. A data estimator may then estimate the velocity and direction of drum rotation based on the coordinates of the marker. The computer vision platform 1330 may also remove erroneous detections, handle registration and assignment functions, estimate instantaneous velocity, and estimate a final velocity.

The application communication 1340 and shared memory 1310 may exchange queries for the latest velocities (e.g., mixer drum rotation speeds). The application communication 1340 may grab a signal count to track input signals 1350 via General Purpose Input Output (“GPIO”) pins 1360. A GPIO manager may be, for example, responsible for gathering water meter data from the GPIO pins 1360. The application communication 1340 may also interact with Bluetooth communication 1370 (output signals to smartphone) and/or local files 1380 (e.g., output log files). According to some embodiments, a backup manager may save and/or backup data when Internet is not available (may also handle loading this data when the Internet connection is again established). For example, the device may store information until it is grabbed via Bluetooth, the internet, or some other communication technique. A network manager may keep track of the network status (e.g., online or offline).

According to some embodiments, GPIO pins 1360 or other 10 ports may let the system 1300 collect information other than water meter data and act as an information hub to gather various types of different information. For example, the system might collect environment information (e.g., any information that can be gathered from what is around the truck and might be relevant to know for the concrete, the truck, an operating company, etc.). For example, an outside temperature sensor (which can influence the concrete), a barometer, a moisture sensor, a gas sensor, a wind sensor, etc. As another example, the system might gather truck information related to the truck itself. For example, Global Positioning System (“GPS”) information, additional dashboard cameras may keep the last n-hours of footage in case there is an automobile accident). In this way, the system 1300 may act as a “black box” of the truck. Other examples include maintenance data, truck details (e.g., fuel level and consumption, door opening and brake events, oil level, velocity/acceleration, failure detection, tire pressure information, etc.).

As still other examples, the system 1300 might collect information about the concrete in addition to the water meter data. For example, the system 1300 might measure concrete load and/or pressure sensor data, a density of the concrete inside the drum mixer, concrete slump parameters, etc. In some embodiments, the system 1300 may further collect information about the truck or driver. For example, driver or operator authentication (this might also be done via a smartphone application, but some embodiments may attach a screen or a fingerprint reader to the system 1300 to collect the authentication details). The system 1300 might also measure a driver's attention to the road, driver habits that influence fuel consumption, etc.

In some embodiments, specifications of a JavaScript Object Notation (“JSON”) message, sent to Android by the sensor, may be defined. For example, each message may contain a list of dictionaries, with each dictionary having the information relative to what happened in a specific interval. A n seconds interval (e.g., set to 5) means that each n seconds the sensor will attempt to communicate with the Android device with a summary of what happened in the last n seconds. If the sensor fails to do so, it will store that information and after n seconds and will try again (but now with a list containing two dictionaries for the old, failed communication and the new one). The sensor may start dropping messages after x messages are stored.

Each dictionary might have the following structure:

{
‘rpm’: float with signal representing the direction
‘waterMeterCounter’: int −> difference between consecutive
samples,
‘timeStamp’: float with result of python's time.time( ) −> time in
seconds since the epoch (January 1, 1970, 00:00:00 (UTC)),
‘status’: int,
‘sensorName’: string with the device name
}

In this case, an example of single message may look as follows:

[{‘rpm’: 99999, ‘waterMeterCounter’: 1, ‘timeStamp’: xxx.xxx,
‘status’: 0, ‘sensorName’: ‘Sensor1’}]

The “status” might indicate, for example: 0 (tracking), 1 (tracking and inversion detected), 2 (working, calibrating), 3 (working, calibration timed out, will use backup value), 4 (working, no markers detected), or 5 (loading and if there are more than one of these a reboot may be requested).

According to some embodiments, there are three modes of execution: tracking, streaming, and pairing. Tracking is the normal mode where the drum rotations are analyzed, and the list of dictionaries is sent to the Android device. Streaming is the mode that is activated when configuring the sensor on the truck and makes the sensor start streaming images from the camera to the Android device. Pairing is the mode where the sensor enters into Bluetooth pairing mode and waits n seconds for an Android device to start the pairing process. Tracking and streaming may be controlled by the Android device. Pairing may be controlled by pressing a physical button on the sensor and may automatically disable the other two modes.

According to some embodiments, a log file may be arranged as follows:

```
logging:
  localBackup:
    folder: /home/example/Log
    frequency: 3
    maxStoredSamples: 40
  maxLogFiles: 20
```

The frequency may control the frequency (in seconds) of saving samples and/or messages to disk (relevant when the Android device is not listening to the sensor communication). The maxStoredSamples defines a number of samples that are stored on disk (after which the sensor starts to drop older messages). The maxLogFiles defines a number of .log files kept on the sensor (after which the old .log files are deleted when a new execution starts).

A server information and communication configuration might be structured as follows:

```
serverInformation:
    samplingRate: 0.3
  updateFrequency: 5
  toleranceRotation: 1.5
  deviceOS: Android
  connectionTimeout: 5
  maxSamplesPerMessage: 10
```

The samplingRate is the rate at which the communication class grabs the information from the estimator. This value (in seconds) should not be too fast to avoid, as much as possible, the introduction of delays in the rest of the pipeline. The updateFrequency defines a frequency (in seconds) of communication to the server. The updateFrequency should be divisible by sampling rate (if it is not, then the update frequency will be adjusted to the closest divisible value of the sampling rate. The toleranceRotation defines a value above which variations RPM do not count as noise (e.g., based on the variance). The connectionTimeout defines (in seconds) a delay establish a new connection in case the existing connection is broken. The maxSamplesPerMessage defines a number of messages the sensor will try to send on a communication to the Android device.

According to some embodiments, water meter information may be structured as follows:

```
waterMeter_GPIO:
  inputPin: 23
  intervalBetweenReads: 0.5
```

The inputPin defines the pin to which the water mater signal is passed. The program may listen for pulses on this pin. The intervalBetweenReads is the smallest interval possible for new signals to be passed to the inputPin. This may, for example, avoid false detections and/or bounces in the signal.

Note that the calculations described with respect to the computer vision platform 1330 represent only one way that camera data might be analyzed. In some embodiments, machine learning may help facilitate computation of drum direction and/or velocity (e.g., including deep learning and/or optical flow methods). Note that there are many different approaches to detect the characteristic of a substance, which in some scenarios might the rotation direction of the drum. One approach may be based on detecting marking symbols on each frame independently, matching them between consecutive frames and using this information to estimate drum rotation velocity and direction. It may rely on pattern matching a symbol that has been defined a-priori and that contributes to the robustness of results to negative effects of a construction environment (which can be extreme). Moreover, when a truck is moving between construction spots, it might also be relevant to track rotation and/or environmental information. In this case, the environment may be constantly changing which may introduce substantial challenges in achieving robust results.

As another approach, the computer vision platform 1330 may detect and identify the marking symbols in a single, combined step. For example, deep learning (e.g., using a Convolutional Neural Network (“CNN”)) might be used for this task of object and/or marking symbol detection. There are also other techniques which include describing an object with its features and finding if these features are in a new image, (e.g., using a Histogram of Oriented Gradients (“HOG”)) combined with a Support Vector Machine (“SVM”)). In general, the computer vision platform 1330 might implement computer vision, pattern recognition, pattern tracking, etc. Once the symbols are uniquely (and correctly) identified on consecutive frames, it is straightforward to compute the direction (note that wrong identifications may negatively impact system 1300 performance).

In other approaches, the computer vision platform 1330 may detect features directly on the drum from a random pattern that is unknown a-priori, and track this information using techniques, such as an optical flow or Kalman filter, to extract the correspondence and/or velocity between consecutives frames and proceed as in the previous method. Features could refer to corners, edges, surfaces or, at the lowest level, pixels that are tracked between consecutive frames. Methods named before fall into more classical computer vision approaches, but more recently deep learning and reinforcement learning (for example) have also been successfully employed to directly detect pixel velocity.

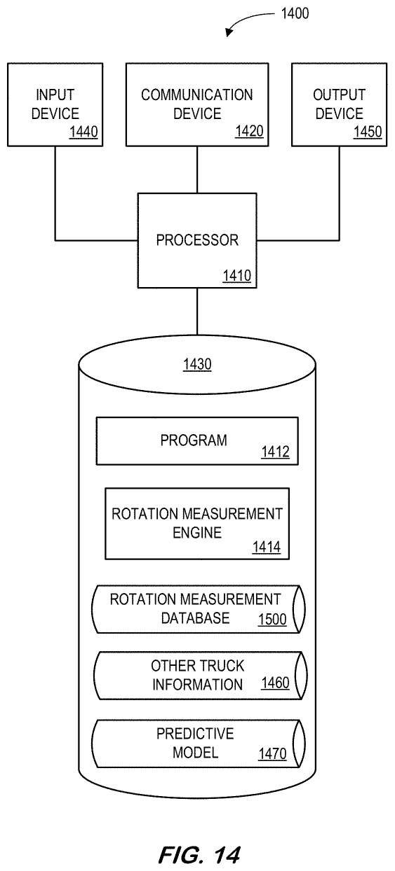

The embodiments described herein may be implemented using any number of different hardware configurations. For example, FIG. 14 illustrates a platform or apparatus 1400 that may be, for example, associated with the system 1200 of FIG. 12 as well as the other systems described herein. The apparatus 1400 comprises a processor 1410, such as one or more commercially available Central Processing Units (“CPUs”) in the form of one-chip microprocessors, coupled to a communication device 1420 configured to communicate via a communication network (not shown in FIG. 14). The communication device 1420 may be used to communicate, for example, with one or more cameras or remote servers. The apparatus 1400 further includes an input device 1440 (e.g., a mouse and/or keyboard to define mixer truck parameters) and an output device 1450 (e.g., a computer monitor to display reports and test results to an administrator).

The processor 1410 also communicates with a storage device 1430. The storage device 1430 may comprise any appropriate information storage device, including combinations of magnetic storage devices (e.g., a hard disk drive), optical storage devices, mobile telephones, and/or semiconductor memory devices. The storage device 1430 stores a program 1412 and/or a surface treatment engine 1414 for controlling the processor 1410. The processor 1410 performs instructions of the programs 1412, 1414, and thereby operates in accordance with any of the embodiments described herein. For example, the processor 1410 may communicate with a camera (e.g., a video or IR camera located in a cabin area of a truck) to capture images of a surface of a concrete mixer truck drum. The processor 1410 may then automatically analyze the captured images to determine drum rotation information (e.g., a drum rotation speed and/or drum rotation direction). The processor 1410 may output an indication of the determined drum rotation information.

The programs 1412, 1414 may be stored in a compressed, uncompiled and/or encrypted format. The programs 1412, 1414 may furthermore include other program elements, such as an operating system, a database management system, and/or device drivers used by the processor 1410 to interface with peripheral devices.

As used herein, information may be “received” by or “transmitted” to, for example: (i) the apparatus 1400 from another device; or (ii) a software application or module within the apparatus 1400 from another software application, module, or any other source.

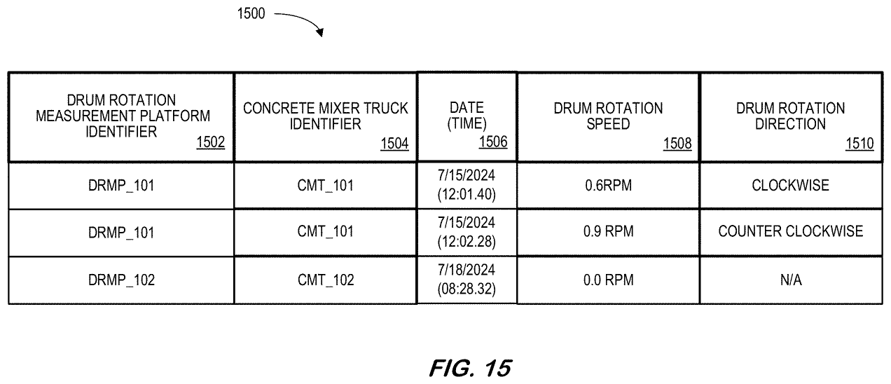

In some embodiments (such as shown in FIG. 14), the storage device 1430 further stores a rotation measurement database 1500, other truck information 1460, and a predictive model 1470 (e.g., to analyze past rotation information using Machine Learning (“ML”) and make predictions). An example of a database that may be used in connection with the apparatus 1400 will now be described in detail with respect to FIG. 15. Note that the database described herein is only one example, and additional and/or different information may be stored therein. Moreover, various databases might be split or combined in accordance with any of the embodiments described herein.

Referring to FIG. 15, a table is shown that represents the rotation measurement database 1500 that may be stored at the apparatus 1400 according to some embodiments. The table may include, for example, entries identifying. The table may also define fields 1502, 1504, 1506, 1508, 1510 for each of the entries. The fields 1502, 1504, 1506, 1508, 1510 may, according to some embodiments, specify: a drum rotation measurement platform identifier 1502, a concrete mixer truck identifier 1504, a date and time 1506, a drum rotation speed 1508, and a drum rotation direction 1510. The rotation measurement database 1500 may be created and updated, for example, based on information received from an operator or administrator (e.g., when a new system is installed) and/or a camera.

The drum rotation measurement platform identifier 1502 may be, for example, a unique alphanumeric code associated with a measurement device mounted on a truck associated with the concrete mixer truck identifier 1504. The date and time 1506 may indicate when the drum rotation speed 1508 (e.g., in RPM) and the drum rotation direction 1510 (clockwise, counterclockwise, or not moving) were estimated based on information from a camera.

Thus, embodiments may implement velocity and direction tracking of a drum in a concrete truck and use that information to inform when the drum changes direction. Embodiments may run locally on the truck from 12 VDC and be able to access internet on the go. The system may determine the velocity and direction of the drum using a camera and support GPIO communication let additional signals be monitored (e.g., water meter count). According to some embodiments, they system may communicate the information in substantially real-time (although a small delay may be acceptable) via a Representational State Transfer (“REST”) API. Embodiments may manage communication even when a truck is in a location without coverage (e.g., the system may store data locally and send to servers once the truck is back online). Embodiments may communicate the information with an Android or iOS device via Bluetooth and handle the full life of the sensor, including automatic start when turned on, shutdown, unexpected shutdowns, etc. Some embodiments may ensure the device is secure and that implementation code is not easily accessible.

Although specific hardware and data configurations have been described herein, note that any number of other configurations may be provided in accordance with embodiments of the present invention (e.g., in other types of environments including mixer drums that are not mounted on a truck). Moreover, although some embodiments are focused on particular visual algorithms, any of the embodiments described herein could be applied to other types of computer vision techniques.

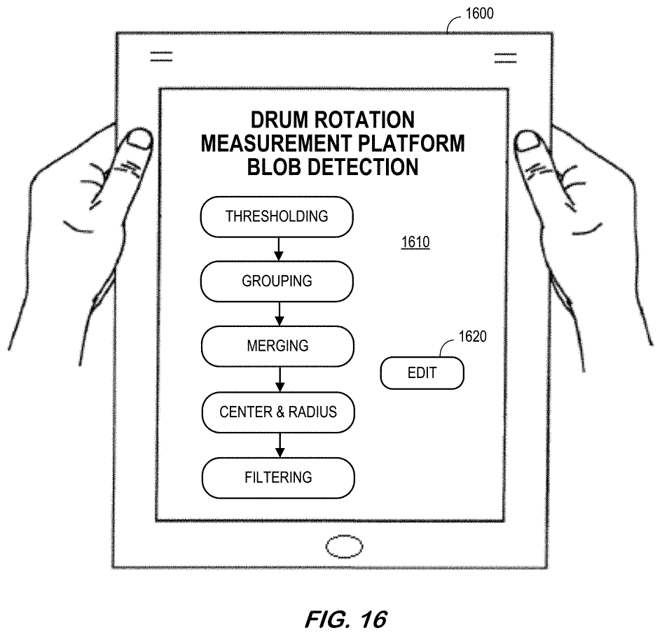

FIG. 16 illustrates a wireless or tablet device 1600 displaying elements of a system in accordance with some embodiments of the present invention. For example, in some embodiments, the device 1600 is an iPhone® from Apple, Inc., a BlackBerry® from RIM, a mobile phone using the Google Android® operating system, a portable or tablet computer (such as the iPad® from Apple, Inc.), a mobile device operating the Android® operating system or other portable computing device having an ability to communicate wirelessly or hardwired with a remote entity. The device 1600 presents a display 1610 that may be used to display information about a computer vision system. For example, the elements may be selected by an operator (e.g., via a touchscreen interface of the device 1600) to view more information about that element and/or to adjust settings or parameters via an “Edit” icon 1620 (e.g., to adjust blob filtering parameters).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system to measure concrete mixer truck drum rotation, comprising:
a camera to capture images of a surface of a concrete mixer truck drum; and
a drum rotation measurement platform, in communication with the camera, including a computer processor and a computer memory storing instructions that, when executed by the computer processor, cause the drum rotation measurement platform to:
(i) receive the images of the surface of a concrete mixer truck drum captured by the camera,
(ii) automatically analyze the captured images to determine drum rotation information, and
(iii) output an indication of the determined drum rotation information.

2. The system of claim 1, wherein the camera comprises at least one of: (i) a video camera, and (ii) an Infra-Red (“IR”) camera.

3. The system of claim 1, wherein the drum rotation measurement platform comprises at least one of: (i) a small board processing unit, (ii) a mini-Personal Computer (“mini-PC”) processing unit, (iii) a tablet computer, (iv) a platform wired to the camera, and (v) a platform in wireless communication with the camera.

4. The system of claim 1, wherein the automatically determined drum rotation information includes at least one of: (i) a drum rotation speed, and (ii) a drum rotation direction.

5. The system of claim 1, wherein the camera is located in a cabin area of the concrete mixer truck.

6. The system of claim 1, wherein the drum rotation measurement platform outputs the indication of the determined rotation information to at least one of: (i) a storage device, (ii) a smartphone, (iii) a tablet computer, (iv) a wireless communication network, and (v) a cloud computing environment.

7. The system of claim 1, wherein the surface of the concrete mixer truck drum includes a marking symbol, and the automatic analysis performed by the drum rotation measurement platform includes detection of movement of the marking symbol between captured images.

8. The system of claim 7, wherein the surface of the concrete mixer truck drum includes a plurality of marking symbols recognized via a computer vision process.

9. The system of claim 8, wherein the captured images include a subset of the plurality of marking symbols.

10. The system of claim 8, wherein the surface of the concrete mixer truck drum includes a plurality of different marking symbol shapes.

11. The system of claim 8, wherein a marking symbol is associated with control parameters.

12. The system of claim 1, wherein the drum rotation information is used to automatically perform at least one of: (i) determination of a characteristic of a substance in the concrete mixer truck drum, (ii) rotation control of the concrete mixer truck drum, (iii) generation of an alert message associated with a substance in the concrete mixer truck drum, and (iv) training of a predictive model.

13. The system of claim 1, wherein the system acts as an information hub and further collects information about at least one of: (i) water meter data, (ii) environment information, (iii) an outside temperature sensor, (iv) a barometer, (v) a moisture sensor, (vi) a gas sensor, (vii) a wind sensor, (viii) Global Positioning System (“GPS”) information, (ix) additional dashboard camera data, (x) maintenance data, (xi) truck fuel level and consumption, (xii) door opening and brake events, (xiii) oil level, (xiv) velocity and acceleration, (xv) failure detection, (xvi) tire pressure information, (xvii) concrete load and/or pressure sensor data, (xviii) a density of the concrete inside the drum mixer, (xix) concrete slump parameters, (xx) information about the truck or driver, (xxi) driver or operator authentication, (xxii) a driver's attention to the road, and (xxiii) driver habits that influence fuel consumption.

14. The system of claim 1, wherein the drum rotation measurement platform is associated with at least one of: (i) computer vision, (ii) pattern recognition, and (iii) pattern tracking.

15. A method to measure concrete mixer truck drum rotation, comprising:
receiving, by a computer processor of a drum rotation measurement platform, images of a surface of a concrete mixer truck drum captured by a camera;
automatically analyzing the captured images to determine drum rotation information; and
outputting an indication of the determined drum rotation information.

16. The method of claim 15, wherein the automatically determined drum rotation information includes at least one of: (i) a drum rotation speed, and (ii) a drum rotation direction.

17. The method of claim 15, wherein the camera is located in a cabin area of the concrete mixer truck.

18. The method of claim 15, wherein the drum rotation measurement platform outputs the indication of the determined rotation information to at least one of: (i) a storage device, (ii) a smartphone, (iii) a tablet computer, (iv) a wireless communication network, and (v) a cloud computing environment.

19. The method of claim 15, wherein the surface of the concrete mixer truck drum includes a plurality of marking symbols, and the automatic analysis performed by the drum rotation measurement platform includes detection of movement of the marking symbols between captured images.

20. A non-transient, computer-readable medium storing instructions that, when executed by a processor, cause the processor to perform a method to measure concrete mixer truck drum rotation, the method comprising:
receiving, by a computer processor of a drum rotation measurement platform, images of a surface of a concrete mixer truck drum captured by a camera;
automatically analyzing the captured images to determine drum rotation information; and
outputting an indication of the determined drum rotation information.

21. The medium of claim 20, wherein the automatically determined drum rotation information includes a drum rotation speed and a drum rotation direction.

22. The medium of claim 20, wherein the camera is located in a cabin area of the concrete mixer truck, the surface of the concrete mixer truck drum includes a plurality of marking symbols, and the automatic analysis performed by the drum rotation measurement platform includes detection of movement of the marking symbols between captured images.
